(19) United States
(12) Patent Application Publication
(10) Pub. No.: US 2007/0241178 A1
(43) Pub. Date: Oct. 18, 2007

(54) Electronically enabled forms

(76) Inventor: Timothy O. Withum, Olney, MD (US)

Correspondence Address: MARSH, FISCHMANN & BREYFOGLE LLP, 3151 SOUTH VAUGHN WAY, SUITE 411, AURORA, CO, 80014, US

(21) Appl. No.: 11/404,344

(22) Filed: Apr. 14, 2006

(51) Int. Cl. G06F 7/00; G06F 9/44; G07B 15/00; G08B 13/14

(52) U.S. Cl. 235/376; 340/572.1; 340/572.8; 705/7; 705/13

(57) ABSTRACT

Electronically readable forms include radio-frequency identification (RFID) devices enabling automated processing of the forms to obtain indicated responses to questions as well as entered information. In one embodiment, an electronically readable form (10) includes a substrate (12), a plurality of response areas (14A-14G) thereon, and a plurality of separate radio frequency identification (RFID) devices (20A-20G) thereon that are associated with the response areas (14A-14G). The response areas (14A-14G) may correspond with answers (16A-16G) to questions (18A-18C). Upon appropriate indication of a response within its associated response area (14A-14G), each RFID device (20A-20G) is enabled to transmit a code (22) in response to an activation signal (30) from an RFID reader unit (32). Each code (22) is different permitting a determination of which response areas (14A-14G) have responses indicated therein based on the codes (22) that are received by the RFID reader unit (32).

### FIELD OF THE INVENTION

The present invention relates generally to the processing of forms and other documents having respondent information entered thereon, and more particularly to automated processing of such forms and other documents.

### BACKGROUND OF THE INVENTION

Obtaining information from respondents responding to, for example, a survey or other questionnaire, applying for a job, completing a loan document, or other forms is a common task. Even though the Internet has become a significant method for the capture of information from respondents, paper forms and other similar hardcopy data capture methods are still widely used to obtain information from respondents. The current state of the art in terms of paper capture includes the optical scanning of completed forms and subsequent automated recognition and capture of the data. This process also usually includes sorting of envelopes, removal of forms from the envelopes and preparation of documents in order to properly optically scan them (e.g., aligning them in a proper orientation such as facing up). Such handling of hardcopy forms is relatively labor intensive and therefore time consuming and costly.

Unfortunately, in today's environment there is a tangible risk of biological or chemical attack through the delivery of hardcopy documents. While there are several methods for detecting such an attack, the resulting impact is one that often involves at least a partial shutdown of a processing facility for cleaning and other related decontamination activities. For time critical programs such as, for example the United States Census, even several days of impacts can result in the data not being captured by and important deadline.

### SUMMARY OF THE INVENTION

Accordingly, the present invention is directed to reducing the amount of handling required in order to obtain information from completed hardcopy forms. The present invention is also directed to reducing the likelihood of contamination at a facility processing completed forms. The present invention provides forms that include radio frequency identification (RFID) devices. RFID devices generally comprise a number of interconnected circuit elements that, when activated, operate to transmit a radio frequency signal in response to an activation or interrogation signal transmitted by an RFID reader unit. In this regard, RFID devices typically do not include a power source and instead utilize the interrogation signal from the RFID reader unit to power generation of the radio frequency signal and can thus be made very small and unobtrusive. As used herein, the terms “activation signal” or “interrogation signal” include a radio-frequency (RF) signal, a magnetic field, an optical signal, or the like output by a device (e.g., an RFID reader unit) to activate an enabled RFID to transmit an RF signal therefrom. The RFID devices included in the forms are either enabled or disabled based on respondent information entered into appropriate areas on the forms. The forms may then simply be interrogated by an RFID reader unit to capture information entered on the forms based on codes transmitted by enabled RFID devices.

According to one aspect of the present invention, an electronically readable form includes a substrate having a plurality of response areas provided on a surface thereof and a plurality of separate RFID devices formed thereon. In one embodiment, the substrate is paper and the RFID devices are formed thereon using a printing process. There may be a plurality of questions and associated answers thereto indicated on the surface of the substrate, and each of the response areas may be associated with one of the answers.

Each of the RFID devices is associated with a different one of the response areas. In one embodiment, each of the RFID devices is enabled to transmit a code in response to an activation signal upon appropriate indication of a response within its associated response area. The code transmitted by each RFID device when enabled and activated by an activation signal (e.g., from an RFID reader unit) is different from codes transmitted by the other RFID devices when enabled and activated. In this regard, the codes may be digital codes. In order to permit batch processing of multiple forms, the digital codes may include a portion identifying a particular form. Regardless of their format, the transmitted codes identify which response areas have an indicated response therein permitting, for example, the indicated answers to the questions to be determined.

In another embodiment, each of the RFID devices is disabled from transmitting a code (e.g., a digital code) in response to an activation signal upon appropriate indication of a response within its associated response area. In this regard, the RFID devices associated with response areas not having responses indicated therein transmit a code instead of the response areas having a response indicated therein. The code transmitted by each RFID device that remains enabled and is activated by an activation signal (e.g., from an RFID reader unit) is different from the codes transmitted by the other enabled and activated RFID devices. Thus, the transmitted codes identify which response areas do not have an indicated response therein permitting, for example, the indicated answers to the questions to be determined based on which codes are not transmitted.

In some instances, responses may be incorrectly or inadvertently indicated within a particular response area. Thus, in accordance with another aspect of the present invention, an electronically readable form may also include a plurality of invalid response indication areas on the surface of the substrate. Each invalid response indication area corresponds with one of the response areas. A plurality of separate invalid response indication RFID devices are also formed on the substrate. Each of the invalid response indication RFID devices is associated with a different one of the invalid response indication areas.

In one embodiment, each invalid response indication RFID device is enabled to transmit a code (e.g., a digital code) in response to an activation signal upon appropriate indication within its associated invalid response indication area indicating that a response entered in the corresponding response area should be ignored. In this regard, the code transmitted by each invalid response indication RFID device when enabled and activated by an activation signal (e.g., from an RFID reader unit) is different from the codes transmitted by other invalid response indication RFID devices as well as from any enabled and activated RFID devices associated with the response areas. Thus, the transmitted codes identify which response areas have an indicated response therein and whether any of the indicated responses are invalid and should be ignored.

In another embodiment, each invalid response indication RFID device is disabled from transmitting a code in response to an activation signal upon appropriate indication within its associated invalid response indication area indicating that a response entered in the corresponding response area should be ignored. In this regard, the code transmitted by each invalid response indication RFID device that remains enabled and is activated by an activation signal (e.g., from an RFID reader unit) is different from codes transmitted by any other invalid response indication RFID devices that remain enabled and are activated as well as any of the RFID devices associated with the response areas that remain enabled and are activated. Thus, the transmitted codes identify, by the absence of codes from any disabled RFID devices and any disabled invalid response indication RFID devices, which response areas have an indicated response therein and whether any of the indicated responses are invalid and should be ignored.

According to another aspect of the present invention, an electronically readable form includes a substrate, one or more response areas provided on a surface of the substrate, one or more arrays of separate RFID devices formed on the substrate, with each array of RFID devices being associated with one of the response areas. In one embodiment, the substrate is paper and the RFID devices are formed on the substrate using a printing process.

In one embodiment, the RFID devices of each array are enabled to transmit codes (e.g., digital codes) in response to an activation signal (e.g., from an RFID reader unit) when such RFID devices underlie information (e.g., text characters, symbols, shapes, pictures, or the like) indicated within their associated response area. In this regard, each code transmitted by the RFID devices when enabled and activated by an activation signal identify a location (e.g., row and column) of their associated RFID device within its associated array. Thus, the transmitted codes from the enabled and activated RFID devices provide a positive image of the information entered in their associated response areas.

In another embodiment, the RFID devices of each array are disabled from transmitting codes in response to an activation signal (e.g., from an RFID reader unit) when such RFID devices underlie information (e.g., text characters, symbols, shapes, pictures, or the like) indicated within their associated response areas. In this regard, the codes transmitted by any RFID devices within an array that remain enabled and are activated by an activation signal identify the location (e.g., row and column) of their associated RFID device within their associated array. Thus, the transmitted codes from the RFID devices that remain enabled and are activated provide a negative image of the information entered in their associated response areas.

These and other aspects and advantages of the present invention will be apparent upon review of the following Detailed Description when taken in conjunction with the accompanying figures.

### DESCRIPTION OF THE DRAWINGS

For a more complete understanding of the present invention and further advantages thereof, reference is now made to the following Detailed Description, taken in conjunction with the drawings, in which:

FIG. 1 shows one embodiment of an electronically readable form in accordance with the present invention, with the form shown being read;

FIG. 2 shows another embodiment of an electronically readable form in accordance with the present invention, with the form shown being read;

FIG. 3 shows one more embodiment of an electronically readable form in accordance with the present invention, with the form shown being read; and

FIG. 4 shows a further embodiment of an electronically readable form in accordance with the present invention, with the form shown being read.

### DETAILED DESCRIPTION

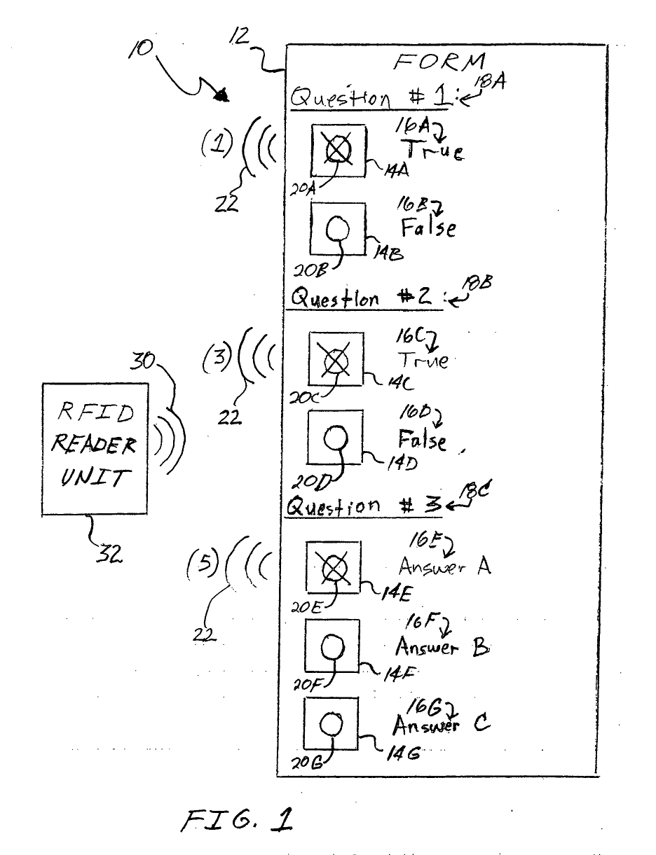

Referring to FIG. 1, one embodiment of an electronically readable form 10 includes a substrate 12 having a plurality of response areas 14A-14G indicated on a surface thereof. The substrate may, for example, comprise a sheet of paper, although in other embodiments the substrate 12 may be other materials such as plastic, cardboard, or other materials suitable for use as a form. The response areas 14A-14G may, for example, be check boxes, selection circles, or the like. The response areas 14A-14G are associated with answers 16A-16G to various questions 18A-18C. For example, response areas 14A-14B may be associated with true and false answers 16A-16B, respectively, to a first question 18A, response areas 14C-14D may be associated with true and false answers 16C-16D, respectively, to a second question 18B, and response areas 14E-14G may be associated with multiple choice answers 16E-16G, respectively, to a third question 18C. In other embodiments, there may be fewer or more questions, answers and response areas than shown in the illustrated embodiment. Regardless of their number, the response areas 14A-14G, answers 16A-16G and questions 18A-18C may all be indicated on the surface of the substrate 12 using, for example, a printing process.

The electronically readable form 10 also includes a plurality of RFID devices 20A-20G formed on the substrate 12. The RFID devices 20A-20G may, for example, be formed during the same printing process used to indicate the response areas 14A-14G, answers 16A-16G and questions 18A-18C. In this regard, specialized inks including appropriate electrically conductive materials may be used. Each RFID device 20A-20G is separate from the other RFID devices 20A-20G and is associated with one of the response areas 14A-14G. In this regard, as is shown, the entire RFID device 20A-20G associated with a particular response area 14A-14G may be formed within its associated response area 14A-14G. However, in other embodiments, only a portion of one or more of the RFID devices 20A-20G may be formed within its associated response area 14A-14G.

When formed, each of the RFID devices 20A-20G is disabled. In this regard, the RFID devices 20A-20G will not operate to transmit RF signals in the presence of an interrogation signal from an RFID reader unit. However, upon appropriate indication of a response within its associated response area 14A-14G, each RFID device 20A-20G becomes enabled to transmit an RF signal when activated by the presence of an interrogation signal from an RFID reader unit. In this regard, each RFID device 20A-20G may be configured to become enabled in a number of manners. For example, electrically conductive ink or pencil lead used to indicate a response within a response area 14A-14G may function as a conductor that completes a circuit thereby enabling operation of the associated RFID device 20A-20G. In another example, the RFID devices 20A-20G may include several layers of material that complete a circuit allowing the RFID devices 20A-20G to become enabled for operation when pressure is applied within their associated response areas 14A-14G using a writing instrument, stylus, or the like. In a further example, electrically conductive stickers (or other user applied material) may complete a circuit enabled the RFID devices 20A-20G for operation upon application thereof within the associated response areas 14A-14G. In one more example, a chemical reaction may be initiated upon application of a material (e.g. a catalyst included in ink) within the response areas 14A-14G to enable the RFID devices 20A-20G for operation. One or more of these and other methods of enabling the RFID devices 20A-20G may all be employed within a single form 10, including with respect to any individual RFID device 20A-20G.

Each RFID device 20A-20G of the electronically readable form 10 transmits an RFID code in the presence of an interrogation signal 30 from an RFID reader unit 32 if such RFID device 20A-20G has been enabled by appropriate indication of a response within its associated response area. For example, when enabled and interrogated, the seven RFID devices 20A-20G may transmit different digital codes corresponding to different integer values such as, for example, the following:

| RFID | | Integer |
|---|---|---|
| Device | Digital Code | Value |
| 20A | 0001 | 1 |
| 20B | 0010 | 2 |
| 20C | 0011 | 3 |
| 20D | 0100 | 4 |
| 20E | 0101 | 5 |
| 20F | 0110 | 6 |
| 20G | 0111 | 7 |

In the above example, a four bit digital code has been illustrated. Such four bit digital code accommodates up to 15 separate RFID devices, assuming that each RFID device is configured to transmit a different code as in the above example and that the digital code ‘0000’ (integer value 0) is not used. If necessary, depending upon how many RFID devices are included in a form, the digital codes may be fewer than four bits long or greater than four bits long. Further, one or more bits may be used as parity or error checking bits. Also, in order to reduce the possibility that one enabled RFID device might be misread for another disabled RFID device, some digital codes may be skipped (e.g., the seven RFID devices 20A-20G may be assigned digital codes corresponding with integer values 1, 3, 5, 7, 9, 11, and 13).

In FIG. 1, several response areas 14A, 14C, and 14E are shown with responses indicated therein, and thus the RFID devices 20A, 20C, and 20G associated therewith are enabled. Since responses are not indicated in response areas 14B, 14D, 14F and 14G, the RFID devices 20B, 20D, 20F and 20G associated therewith remain disabled. Therefore, in response to the interrogation signal 32 from the RFID reader 30, only RFID devices 20A, 20C and 20G transmit their respective RFID codes 22 (e.g., integer values 1, 3 and 5). The form 10 is electronically read by receiving the transmitted RFID codes 22 with the RFID reader unit 32. The received RFID codes 22 may be further processed by the reader unit 32 or communicated to another processing device (not shown) connected therewith (e.g., a computer system) to determine that answers 16A, 16C and 16E have been provided to the questions 18A-18C based on the receipt of RFID codes 22 from the enabled RFID devices 20A, 20C and 20E.

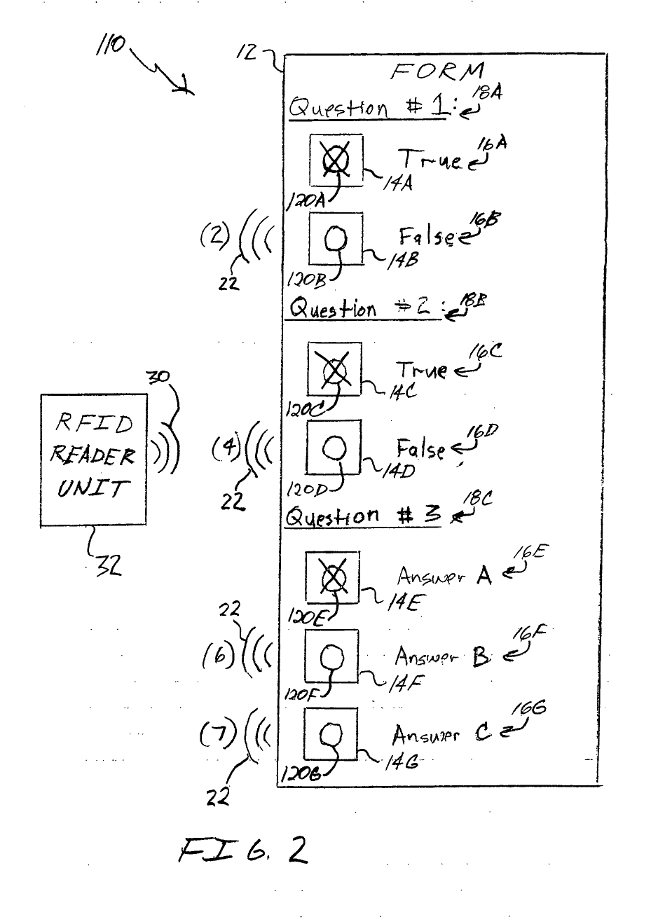

Referring to FIG. 2, another embodiment of an electronically readable form 110 is shown. The form 110 of FIG. 2 is similar to the form 10 of FIG. 1 and elements that may be the same are referenced using the same reference numerals. With respect to the form 110 of FIG. 2, instead of being disabled and requiring appropriate indications within associated response areas in order to become enabled, each of the RFID devices 120A-120G is enabled when formed on the substrate 12. In this regard, the RFID devices 120A-120G operate to transmit their respective codes 22 in the presence of an interrogation signal 30 from an RFID reader unit 32, unless the RFID devices 120A-120G are disabled prior to interrogation. The codes transmitted by the RFID devices 120A-120G when enabled and interrogated may, for example, be specified as previously described in connection with the RFID devices 20A-20G of electronically readable form 10.

Upon appropriate indication of a response within its associated response area 14A-14G, each RFID device 120A-120G of electronically readable form 110 becomes disabled and will not transmit its respective code 22 in the presence of the interrogation signal 30 from the RFID reader unit 32. In this regard, each RFID device 120A-120G may be configured to be disabled in a number of manners. For example, an instrument (e.g., a hole punch, a pin, the point of a pen or pencil, a knife, scissors or the like) may be used to remove an RFID device 120A-120G or a portion thereof within its associated response area 14A-14G. In another example, the RFID devices 120A-120G may be disabled in response to pressure is applied within their associated response areas 14A-14G using a writing instrument, stylus, or the like. In this regard, such pressure might physically damage the RFID device 120A-120G thereby rendering it inoperative or such pressure might initiate a chemical reaction that disables the RFID device 120A-120G. In a further example, stickers (or other similar user applied material) may disable the RFID devices 120A-120G for operation upon application thereof within the associated response areas 14A-14G. In one more example, a scratch off material may be provided within the response areas 14A-14G and upon sufficient removal of the scratch-off material from the response areas 14A-14G the RFID devices 120A-120G are disabled. One or more of these and other methods of disabling the RFID devices 120A-120G may all be employed within a single form 110, including with respect to any individual RFID device 120A-120G.

In FIG. 2, several response areas 14A, 14C, and 14E are shown with responses indicated therein, and thus the RFID devices 120A, 120C, and 120G associated therewith are disabled. Since responses are not indicated in response areas 14B, 14D, 14F and 14G, the RFID devices 120B, 120D, 120F and 120G associated therewith remain enabled. Therefore, in response to the interrogation signal 32 from the RFID reader 30, RFID devices 120B, 120D, 120F and 120G transmit their respective RFID codes 22 (e.g., integer values 2, 4, 6 and 7), while RFID devices 120A, 120C and 120E do not transmit any RFID codes therefrom. The form 10 is electronically read by receiving the transmitted RFID codes 22 with the RFID reader unit 32. The received RFID codes 22 may be further processed by the reader unit 32 or communicated to another processing device (not shown) connected therewith (e.g., a computer system), to determine that answers 16A, 16C and 16E have been provided to the questions 18A-18C based on the absence of received RFID codes 22 from the disabled RFID devices 120A, 120C and 120E.

Regardless of whether a particular form is configured with RFID devices 20A-20G that are initially disabled or with RFID devices 120A-120G that are initially enabled, forms 10, 110 such as shown in FIGS. 1 and 2 facilitate the process of obtaining the information entered thereon. In this regard, since the forms are read electronically based on the RF codes 22 transmitted therefrom, there is no need to remove a form 10, 110 from an envelope or other package containing such form 10, 110. This reduces the amount of steps involved in processing forms and also reduces the possibility that a harmful substance or other contaminant might be released upon opening the envelope or other packaging.

Forms such as the previously described forms 10, 110 shown in FIGS. 1 and 2 are best suited for being processed individually. In this regard, only one such form 10, 110 should be within the read area of the RFID reader unit 32. If multiple copies of a form 10, 110 are simultaneously interrogated, the codes 22 transmitted by the enabled RFID devices 20A-20G, 120A-120G of one form 10, 110 cannot be distinguished between the codes 22 transmitted from another form 10, 110.

It is possible to configure the RFID devices 20A-20G, 120A-120G of the forms 10, 110 such that simultaneous processing of multiple forms 10, 110 is permitted. One manner of doing so is to include a code identifying a particular form 10, 110 within the digital codes 22 transmitted by each RFID device 20A-20G, 120A-120G when enabled and interrogated. For example, an eight bit digital code may be used in which the first four bits identify an individual form 10, 110 and the second four bits identify an individual RFID device 20A-20G, 120A-120G. In this regard, the digital code ‘0001 0001’ corresponding with integer values (1,1) may identify the first form 10 and the first RFID device 20A thereof, and the digital code ‘0010 0111’ may identify the second form 110 and the seventh RFID device 120G thereof.

Such eight bit digital code accommodates up to 15 separate forms each having 15 separate RFID devices, assuming that each RFID device is configured to transmit a different code and that the digital code ‘0000’ (integer value 0) is not used to identify either a form or an RFID device thereof. If necessary, depending upon how many forms are to be simultaneously processed and the number of RFID devices included in each form, the digital codes may be fewer than eight bits long or greater than eight bits long, and one or more bits may be used as parity or error checking bits. Additionally, in order to reduce the possibility that one enabled RFID device might be misread for another disabled RFID device, some digital codes may be skipped. Permitting simultaneous processing of multiple forms 10, 110 by the RFID reader device 32 allows the forms to be placed in the reader area of the RFID reader device 32 in bins or other such containers thereby further reducing the amount of individual handling of the forms 10, 110.

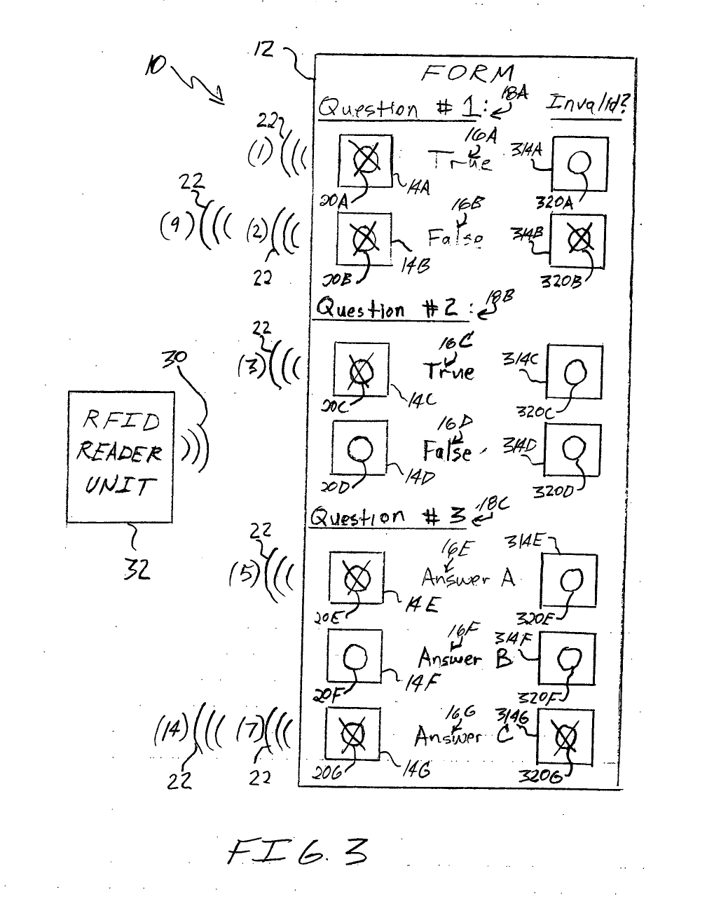

Referring to FIG. 3, another feature that may be included in forms 10, 110 such as illustrated in FIGS. 1 and 2 are invalid response indication areas 314A-314G. Since most techniques for enabling or disabling an RFID device do not permit such enablement or disablement to be reversed, the response areas 14A-14G on a form 10 such as shown in FIG. 1 may be paired with corresponding invalid response areas 314A-314G. Additional RFID devices 320A-320G are associated with the invalid response indication areas 314A-314G. When one of the response areas 20A-20G is improperly or inadvertently marked, an indication may be made (using the aforementioned techniques) in its corresponding invalid response indication area 314A-314G, and the RFID devices 320A-320G associated with any invalid response indication areas 314A-314G are enabled (or disabled in the case of a form 110 such as shown in FIG. 2). The codes 22 transmitted from any enabled RFID devices 320A-320G (or the lack of transmitted codes therefrom) indicate that transmitted codes 22 from their corresponding RFID devices 20A-20G (or the lack of transmitted codes therefrom) are invalid and should be ignored during subsequent processing.

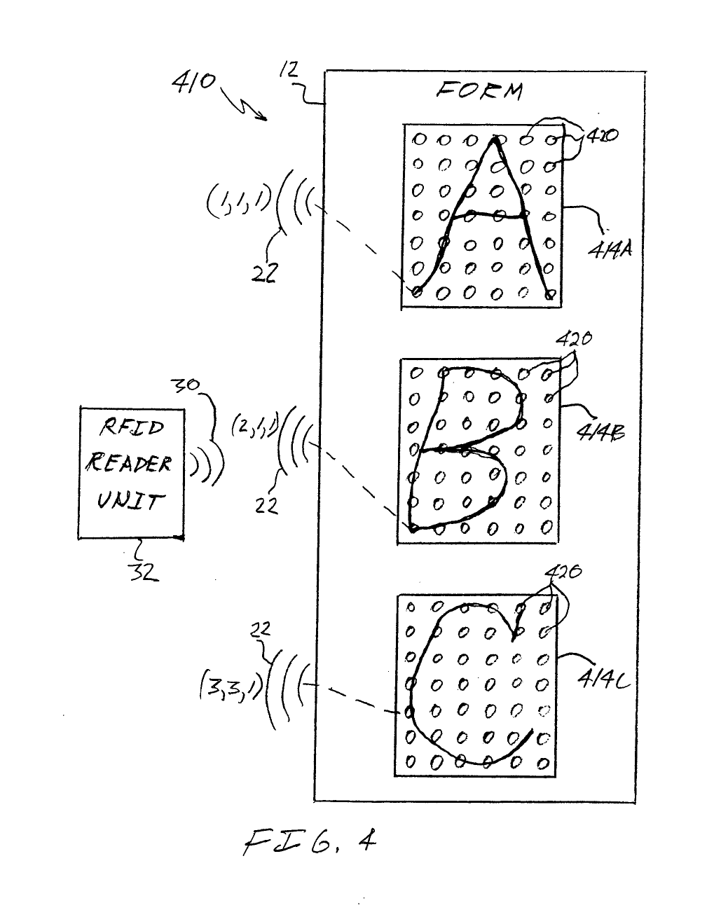

Referring to FIG. 4, an electronically readable form 410 configured for recognition of information (e.g., handwritten or machine created text characters, symbols, shapes, pictures, or the like) includes a substrate 12 similar to that of forms 10, 110 shown in FIGS. 1 and 2. The form 410 also includes one or more response areas 414A-414C within which information may be entered. Arrays 424A-424C of separate RFID devices 420 are formed on the substrate 12, with each array 424A-424C being associated with one of the response areas 414A-41C. As previously discussed in connection with forms 10, 110 of FIGS. 1 and 2, the RFID devices 420 may be configured to be in either an enabled or disabled state. Upon entry of information using a writing instrument (e.g., a pen or pencil), a typewriter, a printer or some other method of entering information within a response area 414A-414C, the RFID devices 420 underlying the entered information are enabled (if originally in a disabled state) or disabled (if originally in an enabled state).

When interrogated by the RFID reader unit 32, an image of the information entered within a response area 414A-414C is obtained based on which RFID devices 420 within a given array 424A-424C are enabled or disabled. In this regard, each enabled RFID device 420 in the arrays 424A-424C may transmit a different code 22. For example, a ten bit digital code may be used wherein the first two bits identify which array 424A-424C a particular RFID device 420 is included, the next four bits identify the row in which a particular RFID device 420 is included, and the final four bits identify the column in which a particular RFID device 420 is included. For example, the ten bit digital code ‘01 0001 0001’ corresponding with integer values (1, 1, 1) can identify the first array 424A and the first row, first column RFID device 420 from the first array 424A. The number of bits required depends in part upon how many arrays there are in the form 410 and the number of rows and columns in each array, as well as whether any bits are used for parity/error checking as well as identifying a particular form in the aforementioned manner. In the case of RFID devices 420 that are initially disabled and are enabled by the entered information, the transmitted codes 22 identify the RFID devices 420 that are enabled with the enabled RFID devices 420 representing positive images of the entered information. In the case of RFID devices 420 that are initially enabled and are disabled by the entered information, the transmitted codes 22 identify the RFID devices 420 that remain enabled with the enabled RFID devices 420 representing negative images of the entered information.

After the RFID reader unit 32 has interrogated the RFID devices 420, images of the information entered in the response areas 424A-424C are generated. Generation of the pixilated images may, for example, be accomplished by the RFID reader unit 32 or, for example, by a computer system (not shown) in communication with the RFID reader unit 32. Thereafter, the images of the entered information may be processed (e.g., by a computer system in communication with the RFID reader unit 32) using optical character recognition/intelligent character recognition (OCR/ICR) software to determine the entered information. Although form 410 is depicted with response areas 414A-414C and associated arrays 424A-424C sized for entry of, for example, a single text character within each response area 414A-414C, it is possible to make the response areas and their associated arrays sized appropriately for entry of, for example, multiple characters. Further, fewer or more response areas and associated arrays can be included on the substrate 10 of form 410 depending upon how much information is intended to be entered on the form 410.

Still further, in other embodiments, one or more single RFID response areas 14A-14G such as in FIGS. 1 and 2 may be combined in a single form with one or more RFID array response areas 414A-414C such as in FIG. 4. Furthermore, a single electronically readable form may comprise multiple substrates (e.g., two or more sheets of paper) with one or more single RFID response areas and/or one or more RFID array response areas provided on each substrate.

While various embodiments of the present invention have been described in detail, further modifications and adaptations of the invention may occur to those skilled in the art. However, it is to be expressly understood that such modifications and adaptations are within the spirit and scope of the present invention.

What is claimed is:

1. An electronically readable form comprising:
a substrate;
a plurality of response areas provided on a surface of said substrate; and
a plurality of separate radio frequency identification (RFID) devices formed on said substrate, each said RFID device being associated with a different one of said response areas;
wherein each said RFID device is enabled to transmit a code in response to an activation signal upon appropriate indication of a response within its associated response area, wherein said code transmitted by each said RFID device when enabled and activated by an activation signal is different from codes transmitted by other said RFID devices when enabled and activated whereby the transmitted codes identify which response areas have an indicated response therein.

2. The electronically readable form of claim 1 wherein said substrate comprises paper.

3. The electronically readable form of claim 2 wherein said RFID devices are formed on said substrate using a printing process.

4. The electronically readable form of claim 1 further comprising:
a plurality of questions and associated answers thereto indicated on the surface of said substrate; and
wherein each said response area is associated with one of said answers.

5. The electronically readable form of claim 1 wherein said codes comprise digital codes.

6. The electronically readable form of claim 5 wherein said digital codes include a portion identifying the form.

7. The electronically readable form of claim 1 further comprising:
a plurality of invalid response indication areas provided on the surface of said substrate, each said invalid response indication area corresponding with one of said response areas; and
a plurality of separate invalid response indication RFID devices formed on said substrate, each said invalid response indication RFID device being associated with a different one of said invalid response indication areas;
wherein each said invalid response indication RFID device is enabled to transmit a code in response to an activation signal upon appropriate indication within its associated invalid response indication area, wherein said code transmitted by each said invalid response indication RFID device when enabled and activated by an activation signal is different from codes transmitted by other said invalid response indication RFID devices and said RFID devices associated with said response areas when enabled and activated whereby the transmitted codes identify which response areas have an indicated response therein and whether any indicated responses are invalid.

8. An electronically readable form comprising:
a substrate;
a plurality of response areas provided on a surface of said substrate; and
a plurality of separate radio frequency identification (RFID) devices formed on said substrate, each said RFID device being associated with a different one of said response areas;
wherein each said RFID device is disabled from transmitting a code in response to an activation signal upon appropriate indication of a response within its associated response area, wherein said code transmitted by each said RFID device when enabled and activated by an activation signal is different from codes transmitted by other said RFID devices when enabled and activated whereby the transmitted codes identify by the absence of transmitted codes from any disabled RFID devices which response areas have an indicated response therein.

9. The electronically readable form of claim 8 wherein said substrate comprises paper.

10. The electronically readable form of claim 9 wherein said RFID devices are formed on said substrate using a printing process.

11. The electronically readable form of claim 8 further comprising:
a plurality of questions and associated answers thereto indicated on the surface of said substrate; and
wherein each said response area is associated with one of said answers.

12. The electronically readable form of claim 8 wherein said codes comprise digital codes.

13. The electronically readable form of claim 12 wherein said digital codes include a portion identifying the form.

14. The electronically readable form of claim 8 further comprising:
a plurality of invalid response indication areas provided on the surface of said substrate, each said invalid response indication area corresponding with one of said response areas; and
a plurality of separate invalid response indication RFID devices formed on said substrate, each said invalid response indication RFID device being associated with a different one of said invalid response indication areas;
wherein each said invalid response indication RFID device is disabled from transmitting a code in response to an activation signal upon appropriate indication within its associated invalid response indication area, wherein said code transmitted by each said invalid response indication RFID device when enabled and activated by an activation signal is different from codes transmitted by other said invalid response indication RFID devices and said RFID devices associated with said response areas when enabled and activated whereby the transmitted codes identify by the absence of codes from any disabled RFID devices and any disabled invalid response indication RFID devices which response areas have an indicated response therein and whether any indicated responses are invalid.

15. An electronically readable form comprising:
a substrate;
at least one response area provided on a surface of said substrate; and
at least one array of separate radio frequency identification (RFID) devices formed on said substrate, said at least one array of RFID devices being associated with said at least one response area;
wherein RFID devices of said at least one array are enabled to transmit codes in response to an activation signal when such RFID devices underlie information indicated within said at least one response area, wherein each said code transmitted by said RFID devices when enabled and activated by an activation signal identify a location of their associated RFID device within said at least one array whereby the transmitted codes provide a positive image of the information entered in said at least one response area.

16. The electronically readable form of claim 15 wherein said substrate comprises paper.

17. The electronically readable form of claim 16 wherein said RFID devices are formed on said substrate using a printing process.

18. The electronically readable form of claim 15 wherein said codes comprise digital codes.

19. The electronically readable form of claim 18 wherein said digital codes include a portion identifying the form.

20. An electronically readable form comprising:
a substrate;
at least one response area provided on a surface of said substrate; and
at least one array of separate radio frequency identification (RFID) devices formed on said substrate, said at least one array of RFID devices being associated with said at least one response area;
wherein RFID devices of said at least one array are disabled from transmitting codes in response to an activation signal when such RFID devices underlie information indicated within said at least one response area, wherein each said code transmitted by said RFID devices when enabled and activated by an activation signal identify a location of their associated RFID device within said at least one array whereby the transmitted codes provide a negative image of the information entered in said at least one response area.

21. The electronically readable form of claim 19 wherein said substrate comprises paper.

22. The electronically readable form of claim 21 wherein said RFID devices are formed on said substrate using a printing process.

23. The electronically readable form of claim 20 wherein said codes comprise digital codes.

24. The electronically readable form of claim 23 wherein said digital codes include a portion identifying the form.
